(19) United States
(12) Patent Application Publication
(10) Pub. No.: US 2009/0177890 A1
(43) Pub. Date: Jul. 9, 2009

(54) Method and Device for Forming a Signature

(75) Inventors: Bernd Mueller, Gerlingen (DE); Werner Harter, Illingen (DE); Eberhard Boehl, Reutlingen (DE); Thomas Haefner, Schwaebisch Gmuend (DE); Gerhard Haefner, Schwabisch Hall (DE); Renate Haefner, Schwabisch Hall (DE); Thomas Kottke, Ehningen (DE); Yorck Von Collani, Beilstein (DE)

Correspondence Address: KENYON & KENYON LLP, ONE BROADWAY, NEW YORK, NY, 10004, US

(73) Assignee: ROBERT BOSCH GMBH, Stuttgart (DE)

(21) Appl. No.: 11/663,714

(22) PCT Filed: Sep. 21, 2005
(86) PCT No.: PCT/EP05/54734

§ 371 Date: Sep. 26, 2008

(30) Foreign Application Priority Data
Sep. 24, 2004 (DE) 10 2004 046 291.7

(51) Int. Cl. G06F 1/00; H04L 9/32; H04L 1/00

(52) U.S. Cl. 713/176

(57) ABSTRACT

A device and a method are for forming a signature for use in a transmitter unit or a receiver unit of a communication system. To speed up the formation of a signature and thus the data transfer between a computer unit (e.g., a microcontroller) and a communication controller of the transmitter unit or the receiver unit, the device is arranged as hardware and the device forms the signature for data which are to be transferred from a computer unit of the transmitter unit to a communication controller of the transmitter unit for the purpose of data transmission via a communication medium of the communication system or which are to be transferred from a communication controller of the receiver unit to a computer unit of the receiver unit for further processing.

### FIELD OF THE INVENTION

The present invention relates to a method and a device for forming a signature for use in a transmitter unit or a receiver unit of a communication system.

In addition, the present invention relates to a transmitter unit of a communication system including a computer unit and a communication controller through which the transmitter unit is connected to a communication medium. The transmitter unit has a device for forming a signature for data which are to be transferred from the computer unit to the communication controller for the purpose of transmission via the communication medium.

The present invention also relates to a receiver unit of a communication system including a computer unit and a communication controller through which the receiver unit is connected to a communication medium. The receiver unit has a device for forming a signature for data which are to be transmitted to the communication controller via the communication medium and which are to be transferred from the communication controller to the computer unit for further processing.

### BACKGROUND INFORMATION

Securing data communication via a communication system in distributed safety-relevant systems by forming a signature for the data to be transmitted is conventional. Such safety-relevant systems are, for example, X-by-wire applications, in particular steer-by-wire, brake-by-wire, and shift-by-wire applications in a motor vehicle. In forming a signature in communication systems, the data to be transmitted from the communication input buffer to the communication output buffer are protected against transmission errors by a signature. One option for forming a signature is, for example, the CRC (Cyclic Redundancy Check). This method is used, for example, in CANs (Controller Area Networks), in FlexRay and in Byteflight.

Conventional methods are, however, effective only from the point in the communication chain at which the signature is formed and up to the point at which the signatures are checked. In the above-named systems, this takes place in the transmission communication controller and the reception communication controller, respectively. To detect errors in the communications chain occurring upstream from the transmission communication controller or downstream from the reception communication controller, i.e., for example, in the memory of the transmitting or receiving computer unit (a so-called microcontroller), according to conventional systems, in the case of particularly sensitive data an additional signature is formed for the data and appended to the data, typically in the form of a so-called application signature formation (for example, in the form of an application CRC). This additional signature is formed and analyzed in the software running on the arithmetic unit of the transmitter unit or of the receiver unit of the communication system and is very resource-intensive, i.e., computing- and time-intensive. The formation of the additional signature represents a bottleneck because the data could be transferred from the arithmetic unit to the communication controller or in the opposite direction from the communication controller to the arithmetic unit actually in parallel, for example, data element by data element, in particular word by word. This means one data element having a plurality of bits, in particular a data word having 8 bits, could be transmitted in each computer cycle. Due to the typically bit-by-bit signature formation in the software, a data element, however, may not be transmitted until all bits of the data element have been involved in the signature formation, i.e., after a plurality of computer cycles has elapsed.

### SUMMARY

Example embodiments of the present invention may speed up the formation of the additional signature and thus the data transfer between the computer unit (the microcontroller) and the communication controller of the transmitter unit or of the receiver unit and/or to relieve the computer unit (microcontroller) from this task and thus free resources for other tasks.

The device may be designed as hardware and the device may form the signature for data which are to be transferred from a computer unit of the transmitter unit to a communication controller of the transmitter unit for the purpose of data transmission via a communication medium of the communication system, or from a communication controller of the receiver unit for further processing on a computer unit of the receiver unit.

Example embodiments of the present invention may facilitate the formation of the additional signature for data which are transferred between the computer unit (the microcontroller or central processing unit, CPU) and the communication controller of a transmitter unit or a receiver unit of a communication system. The arithmetic unit simply transfers those data for which an additional signature is to be formed to the hardware for signature formation and may then turn to other tasks again. The actual signature formation is accomplished by the hardware independently of the arithmetic unit. The hardware for signature formation must be able to be addressed, i.e., supplied with data to be marked by signature and activated, by the arithmetic unit.

The method according to example embodiments of the present invention may be particularly suitable for intra-computer communication in the receiver unit and the transmitter unit of a communication system. Data transmission via the communication medium is rather slow anyway, so that it is not perceptible or disturbing if a plurality of computer cycles is required within the data transmission for signature formation. The situation is different, however, in the intra-computer communication, which is considerably faster. In that case, signature formation may represent a true bottleneck because the communication requires considerably fewer computer cycles than conventional signature formation by the software. Example embodiments of the present invention may be helpful in this case.

According to example embodiments of the present invention, the extensive task of having to regularly form a signature is removed from the arithmetic unit. In addition, a signature formation device implemented in the hardware may be implemented using considerably less complexity and in a substantially simpler manner than would be possible with the aid of software. The hardware for signature formation may be monitored for proper operation without problems. The hardware may be used either for monitoring the communication path within a communication system or for securing any other data within the communication system. The hardware for signature formation offers the possibility to monitor an interface (for example, an SPI (Serial Peripheral Interface) bus) that would be difficult to monitor otherwise.

The hardware for signature formation may be easy to test via software. In order to perform a test, the signature for test data is calculated with the aid of software or with the aid of testing hardware, and the result of the calculation is compared with the output of the hardware for forming signatures.

The signature may be formed and stored before the data transfer between the computer unit and the communication controller. In addition, the signature may be formed and stored without using the computer unit. This means that the computer unit of the transmitter unit or of the receiver unit of the communication system is freed from signature formation and is available for other tasks.

The device may be arranged as a shift register having a plurality of inputs. Such a shift register is also referred to as a Multiple Input Shift Register (MISR).

The device may be arranged as a separate hardware unit of the transmitter unit or of the receiver unit. This separate hardware unit is, unlike conventional CRC logics used in communication controllers, directly addressable by the arithmetic unit. If the arithmetic unit or the software running thereon arrives at the result that a certain data element is to be provided with a signature, this data element is transferred to the hardware unit for signature formation. After a time period known in advance, the result of the signature formation may be retrieved again. The arithmetic unit is thus almost fully unburdened. Occasionally the signature may be formed by the specialized hardware so rapidly that the arithmetic unit is able to wait for the formation of the result after the data have been transferred. This depends, e.g., on the amount of data to be marked with a signature, on the signature method used, and on the type of hardware unit. Waiting for the data to be marked with a signature, however, is not necessary, and advantages of the hardware unit may be utilized, e.g., when the arithmetic unit turns to other tasks during the signature formation.

A much greater portion of the path may be secured than would be possible for the communication protocol itself. The data receiver (which may also be the same arithmetic unit) may test the data by forming its own signature for the data and comparing it with the transmitted signature. Inequality signals an error. The type of the signature is initially not predefined. One possibility is the Cyclic Redundancy Check (CRC). An advantage of the CRC is that it is universally known and allows the Hamming distance to be scalably set. Another alternative is the use of a Multiple Input Shift Register (MISR) or even of an improved MISR that is, described for example, in German Published Patent Application No. 103 51 442. It is important that the receiver of the data marked by a signature is aware of and also uses the exact mechanisms of signature formation at the transmitter.

The data to be marked by a signature may be transferred from the arithmetic unit to the hardware unit via a DMA (Direct Memory Access) controller or a similar mechanism. This means that the hardware unit is informed only of the beginning and the end of a memory area in which the data to be marked by a signature are stored. The signature may be stored in another memory area. One particular advantage of this approach is that from the point of view of the arithmetic unit the interface of the additional hardware unit looks like that of a DMA controller. No special Assembler instructions need to be created anew.

It is possible that the additional hardware unit outputs a “ready” signal as soon as the signature formation is completed. The hardware unit may also be arranged such that it is able to directly access the memory either via the same data bus and address bus as the arithmetic unit or in the form of a dual port RAM (Random Access Memory).

Additional features, possible applications, and aspects of example embodiments of the present invention are described in more detail below with reference to the appended Figures. All features described or illustrated by themselves or in any desired combination represent the subject matter hereof, regardless of their combination or their back-references, and regardless of their wording in the description or illustration in the drawing.

### BRIEF DESCRIPTION OF THE DRAWINGS

FIG. 1 shows a communication system having a transmitter unit according to an example embodiment of the present invention and a receiver unit according to an example embodiment of the present invention.

FIG. 2 shows a hardware unit for signature formation according to an example embodiment of the present invention.

FIG. 3 shows a hardware unit for signature formation according to an example embodiment of the present invention.

### DETAILED DESCRIPTION

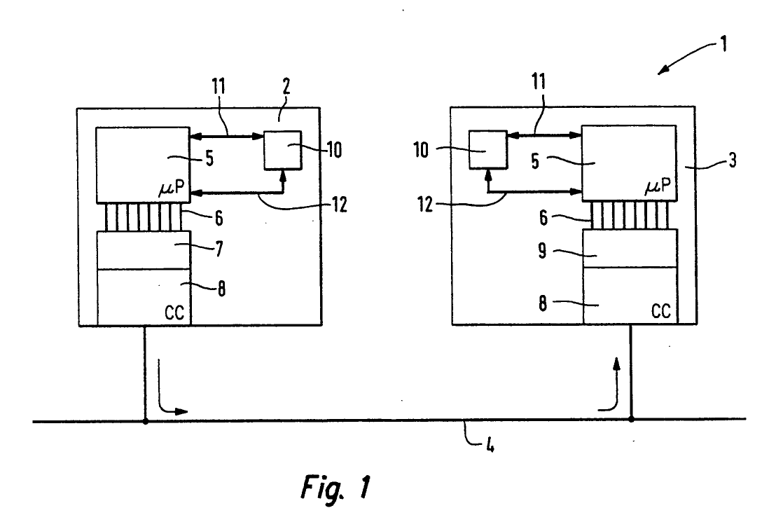

In FIG. 1, a communication system according to an example embodiment of the present invention is labeled with reference numeral 1. The communication system includes two users, one transmitter unit 2 and one receiver unit 3. Data may be exchanged between transmitter unit 2 and receiver unit 3 via a communication medium 4, which is arranged as a data bus, for example. Each of users 2, 3 includes an arithmetic unit 5, which is arranged, for example, as a microprocessor and is also referred to as a Central Processing Unit (CPU). Arithmetic unit 5 of transmitter unit 2 transfers data, which are to be transmitted to receiver unit 3 via communication medium 4, to an output buffer 7 of a communication controller 8 via a plurality of parallel lines 6, e.g., via eight lines. Communication controller 8 of receiver unit 3 transfers the data received from communication medium 4 to arithmetic unit 5 via an input buffer 9 and parallel lines 6 for further processing.

The data to be transmitted are marked with signatures for securing the data transmission via communication medium 4. Communication controller 8 is responsible for marking the data with a signature. Since data are transmitted via communication medium 4 relatively slowly anyway, the signature formation in communication controller 8 results in no delay.

However, it looks differently within the computer. The data transmitted between arithmetic unit 5 and communication controller 8 are also to be secured in some applications at least partially by signature formation. The data transfer between arithmetic unit 5 and the communication controller takes place data element by data element, e.g., word by word. This means that all eight bits of a data word are always transmitted in parallel via lines 6. Therefore, only few computer cycles are needed for the data transfer. When the signature formation takes place more slowly than the data transfer, for example, bit by bit, the signature formation represents a bottleneck which may impair the data rate of the entire communication system 1.

According to example embodiments of the present invention, the signature of the data transferred between arithmetic unit 5 and output buffer 7 or input buffer 9 of communication controller 8 is formed in the hardware. For this purpose, a separate hardware unit 10 is provided, which forms the signature largely independently of arithmetic unit 5. Hardware unit 10 is directly controllable by arithmetic unit 5 via a signal line 11. On the one hand, hardware unit 10 may be activated via signal line 11. On the other hand, however, it is also possible that hardware unit 10 transfers a “ready” signal to arithmetic unit 5 via line 11 as soon as it is finished with the signature formation. In addition, hardware unit 10 has access to the data to be marked with a signature. It is possible that hardware unit 10 receives the data to be marked with a signature from arithmetic unit 5 via a data line 12. The transfer of the data to be marked with a signature to hardware unit 10 may be performed by arithmetic unit 5. It is, however, also possible that hardware unit 10 retrieves the data to be marked with a signature automatically (possibly upon instruction by arithmetic unit 5). It is possible that the communication takes place within the computer. In this case, users 2, 3 of FIG. 1 are configured identically, i.e., as the same unit.

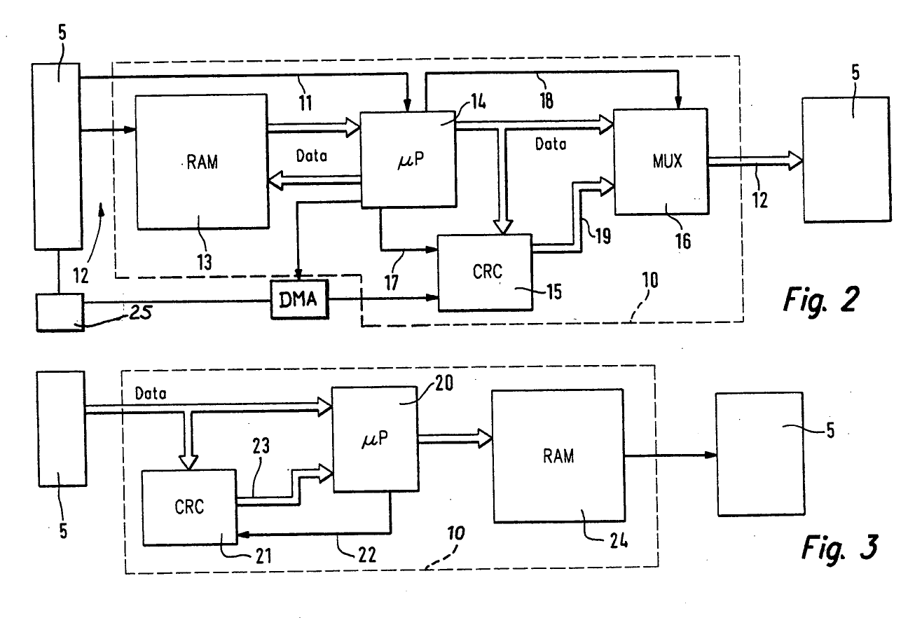

FIG. 2 shows a hardware unit 10′ of an example embodiment of the present invention. Hardware unit 10′ is part of transmitter unit 2 of communication system 1. The data to be marked with a signature are stored by arithmetic unit 5 in a memory 13 of hardware unit 10 via data line 12. An arithmetic unit 14 has access to this memory 13 and is able to read the data.

At a given point in time, arithmetic unit 14 receives a signal from arithmetic unit 5 of transmitter unit 2 via signal line 11 to start signature formation. Arithmetic unit 14 retrieves the data to be marked with a signature from memory 13 and conveys them to a unit 15 for signature formation and to a multiplexer 16. In the example illustrated, unit 15 calculates the CRC. Alternatively, unit 15 may also be arranged as an MISR.

Instead of memory 13, a DMA controller may also be used, which retrieves the data from the memory of a chip 25, which is arranged as a RAM (Random Access Memory), for example, via a DMA access and relays them to unit 15 for signature formation. However, for this purpose, the corresponding memory area of the memory of chip 25 must be identified by arithmetic unit 14, so that the DMA controller accesses the correct memory area. During transfer or reception of the data, it may be even more advantageous to mark the beginning and the end of the relevant data area and to transfer this information from arithmetic unit 5 to hardware unit 10 such that the signature is automatically formed simultaneously with the transmission or reception of the data.

Unit 15 is activated by arithmetic unit 14 via a signal line 17. It links a plurality of data bytes or data words consecutively for signature formation. In addition, arithmetic unit 14 activates multiplexer 16 via an additional signal line 18. The signature of the data appears at the output of unit 15 and is relayed to multiplexer 16 via a data line 19, which incorporates the signature into the data and transmits both via data line 12 back to arithmetic unit 5. The signature does not need to be incorporated into the same message as the data. It is also possible that the signature by itself or the data marked by the signature are written into a special memory area of memory 13 from which they may be retrieved by arithmetic unit 5.

The signature is thus formed in hardware unit 10 fully automatically and almost without using the resources of arithmetic unit 5 of transmitter unit 2. Arithmetic unit 5 may thus perform other tasks during the formation of the signature.

The data marked with the signature are then transferred from arithmetic unit 5 to output buffer 7 of communication controller 8 via parallel lines 6. From there they are transmitted to receiver unit 3 via communication medium 4. A hardware unit 10 for receiver unit 3 is illustrated in detail in FIG. 3. Receiver unit 3 receives the data marked with the signature from communication medium 4 via communication controller 8 and relays them to arithmetic unit 5 via input buffer 9 and the parallel line.

In arithmetic unit 5, the data without signature are extracted from the received information. The data are relayed to an additional arithmetic unit 20 of receiver unit 3 and to a unit 21 for signature formation. Unit 21 uses the same algorithm and the same data for signature formation as unit 15 in transmitter unit 2. Unit 21 is activated by arithmetic unit 20 via a signal line 22. The additional signature formed by unit 21 is transferred to arithmetic unit 20 via data line 23. Arithmetic unit 20 stores the received data, the signature ascertained by unit 15, and the additional signature ascertained by unit 21 in a memory 24. Arithmetic unit 5 of receiver unit 3 may access memory 24 and call the information stored there.

A program running on arithmetic unit 5 performs a comparison of the two signatures and, if the two signatures differ, causes suitable measures to be taken to prevent erroneous data from being further processed in receiver 3. A possible measure, for example, is retransmission of the erroneous data.

Not all data to be transmitted via communication medium 4 need to be marked with a signature with the aid of the method hereof. Instead, a software program running on arithmetic unit 5 decides which data are to be marked with a signature prior to transfer from arithmetic unit 5 to communication controller 8. In general, this is considered for particularly security-relevant data. It is also possible that, in addition to the above-described signature, an additional signature formation for all data is performed prior to the data being transmitted via communication medium 4. A check is first performed in receiver unit 3 using the signature formed for all data of whether the data have been transmitted without error via communication medium 4. Subsequently, a check is performed based on the signature formed by hardware unit 10 of whether the security-relevant data have also been transmitted without error between arithmetic unit 5 and communication controller 8.

1-18. (canceled)

19. A device, comprising:
a hardware device configured to form a signature to be used in at least one of (a) a transmitter unit and (b) a receiver unit of a communication system, the hardware device configured to form the signature for data to be at least one of (a) transferred from a computer unit of the transmitter unit to a communication controller of the transmitter unit for data transmission via a communication medium of the communication system and (b) transferred from a communication controller of the receiver unit to a computer unit of the receiver unit for further processing.

20. The device according to claim 19, wherein the hardware device is configured to form and store the signature before a start of data transfer between the computer unit and the communication controller.

21. The device according to claim 19, wherein the hardware device is configured to form and store the signature without use of the computer unit.

22. The device according to claim 19, wherein the hardware device includes a shift register having a plurality of inputs.

23. The device according to claim 19, wherein the hardware device is arranged as a separate hardware unit of at least one of (a) the transmitter unit and (b) the receiver unit.

24. A transmitter unit of a communication system including a computer unit and a communication controller through which the transmitter unit is connected to a communication medium, comprising:
a hardware device configured to form a signature for data to be transferred from the computer unit to the communication controller for transmission via the communication medium.

25. The transmitter unit according to claim 24, wherein the hardware device is configured to form and store the signature before a start of data transfer between the computer unit and the communication controller.

26. The transmitter unit according to claim 24, wherein the hardware device is configured to form and store the signature without use of the computer unit.

27. The transmitter unit according to claim 24, wherein the hardware device includes a shift register having a plurality of inputs.

28. The transmitter unit according to claim 24, wherein the hardware device is arranged as a separate hardware unit of the transmitter unit.

29. A receiver unit of a communication system including a computer unit and a communication controller through which the receiver unit is connected to a communication medium, comprising:
a hardware device configured to form a signature for data transferred to the communication controller via the communication medium and to be transferred from the communication controller to the computer unit for further processing.

30. The receiver unit according to claim 29, wherein the hardware device is configured to form and store the signature before a start of data transfer between the computer unit and the communication controller.

31. The receiver unit according to claim 29, wherein the hardware device is configured to form and store the signature without use of the computer unit.

32. The receiver unit according to claim 29, wherein the hardware device includes a shift register having a plurality of inputs.

33. The receiver unit according to claim 29, wherein the hardware device is arranged as a separate hardware unit of the receiver unit.

34. A method for forming a signature to be used in at least one of (a) a transmitter unit and (b) a receiver unit of a communication system, comprising:
forming the signature by a hardware unit for data to be at least one of (a) transferred from a computer unit of the transmitter unit to a communication controller of the transmitter unit for data transmission via a communication medium of the communication system and (b) transferred from a communication controller of the receiver unit to a computer unit of the receiver unit for further processing.

35. The method according to claim 34, wherein the signature is formed and stored before a start of data transfer between the computer unit and the communication controller.

36. The method according to claim 34, wherein the signature is formed and stored without use of the computer unit.
